(19) United States
(12) Patent Application Publication
(10) Pub. No.: US 2007/0223902 A1
(43) Pub. Date: Sep. 27, 2007

(54) Image formation optical unit

(75) Inventor: Syunji Nishimura, Saitama-shi (JP)

Correspondence Address: BIRCH STEWART KOLASCH & BIRCH, PO BOX 747, FALLS CHURCH, VA, 22040-0747, US

(73) Assignee: FUJINON CORPORATION, Saitama-shi (JP)

(21) Appl. No.: 11/723,904

(22) Filed: Mar. 22, 2007

(30) Foreign Application Priority Data
Mar. 23, 2006 (JP) 2006-080440

(51) Int. Cl. G03B 17/00

(52) U.S. Cl. 396/72

(57) ABSTRACT

An image formation optical unit is provided. In the image formation optical unit, a first shaft formed with a guide shaft and a drive shaft and a second shaft formed with a guide shaft and a drive shaft are disposed side by side so as to extend in parallel with a second optical axis direction. A free space is thus provided in the center and further two motors and are disposed in a free space at the rear of a prism, thereby making it possible to further reduce the dimensions in the height direction.

### BACKGROUND OF THE INVENTION

1. Field of the Invention

This invention relates to an image formation optical unit including a plurality of lens groups, which is for forming subject light via the plurality of lens groups on an image formation surface.

2. Description of Related Art

Some of image formation optical units each including a plurality of lens groups and forming subject light via the plurality of lens groups on an image formation surface may have a zoom lens as an image formation optical system in the unit. When the zoom lens is built in a lens barrel, two drive shafts for separately driving two movable lens groups and two motors for rotating the drive shafts may become necessary in some cases. At this time, guide shafts for guiding the two lens groups in the optical axis direction when the two lens groups move along the drive shafts also become necessary as many as the number of the drive shafts.

One example of an image formation optical unit including an optical system of a zoom lens is taken to describe the configuration of the unit.

FIGS. 1 and 2 are drawings to show an image formation optical unit in which a refractive optical system of a zoom lens is disposed.

FIG. 1 is a perspective view of observing an image formation optical unit 10 from above in a slight slanting direction, and FIG. 2 is a front view of the image formation optical unit 10 in FIG. 1. FIGS. 1 and 2 show the image formation optical unit including a refractive optical system having a plurality of lens groups 11 to 15 containing a prism 111 of a reflecting optical element for reflecting subject light incident along a first optical axis OP1 directed forward to a direction along a second optical axis OP2 crossing the first optical axis OP1.

In the example, to slim down a camera body, only an objective lens 110 in the first lens group is disposed on the first optical axis OP1 and other lens groups are disposed at the prism 111 and the later. In the example, a first lens group 12 and a second lens group 14 are movable lens groups and lens carriers 121 and 141 for holding the lens groups 12 and 14 are provided with mesh parts (not shown) meshing with lead screws LS1 and LS2 and forks, etc., 121A and 121B and 141A and 141B engaging guide shafts G11 and G12 and G21 and G22. Related arts described in Japanese Patent No. 2725491 and JP-A-5-341168, for example, are used for the mesh parts of the lens carriers with the lead screws and the guide parts, stable drive is provided.

In the image formation optical unit 10 of the example, to reduce the dimensions in the second optical axis direction (corresponding to the height direction in FIG. 2) in addition to the slimming down, the extent of the zoom range is previously determined and the dimensions of the body in the second optical axis direction are defined from the move range of the movable lens groups to accomplish the zoom range so that the movable lens groups and the drive sections are packed within the dimensions, thereby reducing the dimensions in the second optical axis direction.

Thus, a first zoom drive section ZM1 made up of the lead screw LS1, a motor M1, a guide shaft G1, and a bearing part B1 for receiving the end of the lead screw LS1 for rotation for moving the first lens group 12 along the second optical axis direction and a second zoom drive section ZM2 made up of the lead screw LS2, a motor M2, a guide shaft G2, and a bearing part B2 for receiving the end of the lead screw LS2 for rotation for moving the second lens group 14 along the second optical axis direction are packed at a high density with an assembling space between as shown in FIG. 1. The image formation optical unit packed at a high density is built in a small and slim body of a mobile telephone, etc.

However, it will become necessary to further reduce the dimensions in the second optical axis direction for still more miniaturization with the advance of further miniaturization of a digital camera, a mobile telephone with a camera, etc., in the future. In the configuration shown in FIGS. 1 and 2, the two lead screws LS1 and LS2 and the two guide shafts G1 and G2 become necessary and thus the number of members involved in the parts also increases and therefore the dimensions in the height direction can be reduced only within the configuration shown in FIGS. 1 and 2.

### SUMMARY OF THE INVENTION

An object of an illustrative, non-limiting embodiment of the present invention is to provide an image formation optical unit making it possible to further reduce the dimensions thereof by decreasing the number of parts.

According to an aspect of the invention, there is provided an image formation optical unit including a plurality of lens groups and forming subject light via the plurality of lens groups on an image formation surface, wherein some of the plurality of lens groups are movable lens groups that can move in an optical axis direction, the image formation optical unit including:

a first shaft extending in parallel to the optical axis for moving a first lens group of one of the movable lens groups in the optical axis direction by rotation; and

a second shaft extending in parallel to the optical axis for guiding the first lens group when the first lens group is driven by the first shaft and moves in the optical axis direction,

the second shaft moving a second lens group of another one except the first lens group of the movable lens groups in the optical axis direction by rotation.

According to the image formation optical unit, when the first lens group of a movable lens group is driven by the first shaft and moves, the second shaft guides the first lens group in the optical axis direction. At the same time, the second lens group of a movable lens group is driven by the second shaft and the spacing between the first lens group and the second lens group is adjusted, whereby the focal length is adjusted.

This means that the second shaft may be used both as the guide shaft and the drive shaft shown in FIG. 1.

Thus, the number of parts involved in the guide shaft and the drive shaft as which the second shaft is used both is decreased and the need for disposing the parts in the unit is eliminated, so that it is made possible to further reduce the dimensions of the image formation optical unit in the second optical direction thereof.

Further, it is also made possible to dispose the motors for transmitting rotation force to the first shaft and the second shaft in free space in a portion where the ends of the shafts extend, so that flexibility of the layout of the motors is also provided and it is made possible to reduce the dimensions of the image formation optical unit not only in the optical direction, but also in the direction orthogonal to the second optical axis (the width direction shown in FIG. 2).

As described above, the number of the parts is decreased, whereby the image formation optical unit whose dimensions can be further reduced is implemented.

Although the second shaft has both the guide shaft and the drive shaft in the configuration described above, the first shaft may be used both as the guide shaft and the drive shaft.

In so doing, the number of parts involved in the drive shaft and the guide shaft as which the first shaft is used both is also decreased and the need for disposing the parts is also eliminated, so that it is made possible to further reduce the dimensions of the image formation optical unit.

It is also made possible to dispose the first shaft and the second shaft in parallel and assemble both lens groups to the first and second shafts, so that it is made possible to easily make optical axis alignment between the first lens group and the second lens group for easy assembly.

The image formation optical system in the image formation optical unit may be a refractive optical system.

In this case, the image formation optical unit further includes a reflecting optical element for reflecting subject light incident along a first optical axis from the front to a direction along a second optical axis crossing the first optical axis,

wherein the first lens group and the second lens group are placed on the image formation surface side rather than the reflecting optical element, and

wherein the first shaft and the second shaft are disposed so as to extend in parallel with the second optical axis.

### BRIEF DESCRIPTION OF THE DRAWINGS

The features of the invention will appear more fully upon consideration of the exemplary embodiment of the invention, which are schematically set forth in the drawings, in which:

FIG. 1 is a perspective view of observing an image formation optical unit in a related art from above in a slanting direction;

FIG. 2 is a front view of the image formation optical unit 10 in FIG. 1; and

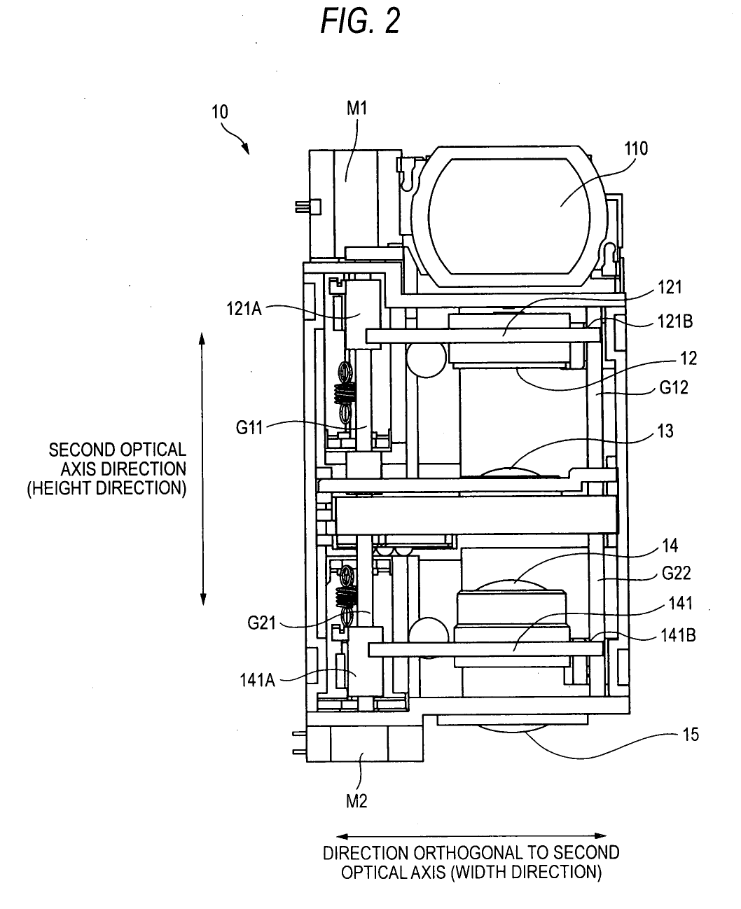

FIG. 3 is a drawing to show the configuration of an image formation optical unit of an exemplary embodiment of the invention.

### DETAILED DESCRIPTION OF THE EXEMPLARY EMBODIMENTS

Although the invention will be described below with reference to the exemplary embodiments thereof, the following exemplary embodiments and modifications do not restrict the invention.

According to an exemplary embodiment, the number of the parts is decreased, whereby the image formation optical unit whose dimensions can be further reduced is implemented.

Referring now to the accompanying drawings, there is shown a preferred embodiment of the invention.

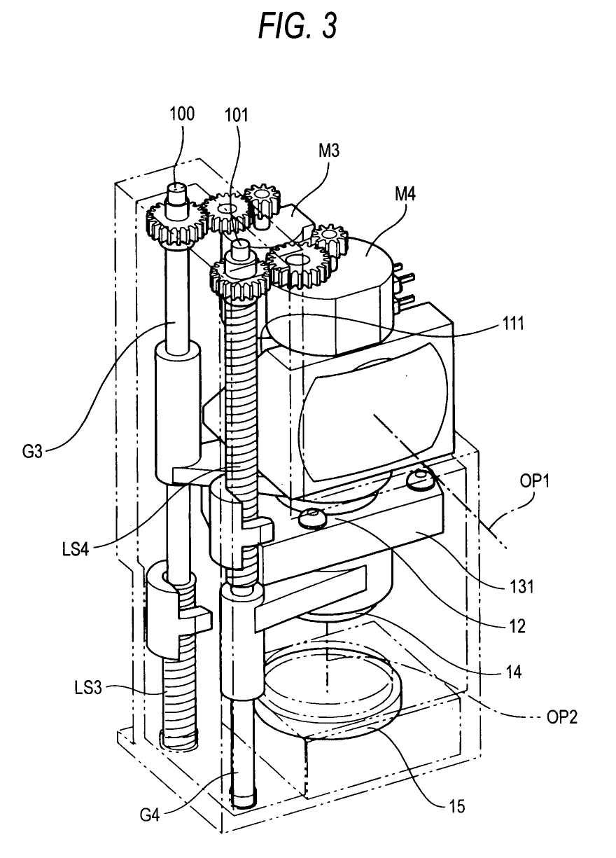

FIG. 3 is a perspective view of observing an image formation optical unit 1 of one exemplary embodiment of the invention from above in a slanting direction, in which a refractive optical system of a zoom lens is disposed from above in the slanting direction.

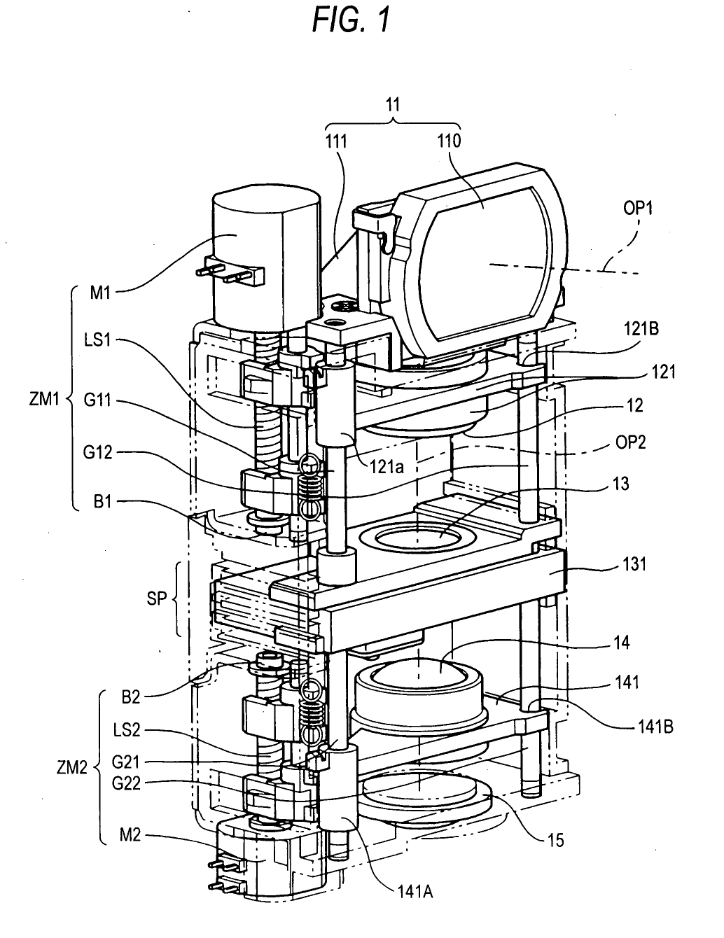

Like FIG. 1, FIG. 3 shows the image formation optical unit including a refractive optical system having a plurality of lens groups 11 to 15 containing a prism 111 of a reflecting optical element for reflecting subject light incident along a first optical axis OP1 directed forward to a direction along a second optical axis OP2 crossing the first optical axis OP1.

In the embodiment, to move the first lens group 12 and the second lens group 14 of movable lens groups along the second optical axis direction, a first shaft 100 formed with a guide shaft G3 and a drive shaft LS3 in one piece and a second shaft 101 formed with a guide shaft G4 and a drive shaft LS4 in one piece are disposed in parallel in a small and slimmed unit. Further, motors M3 and M4 for rotating the shafts 100 and 101 are packed at a high density side by side in a free space on the slope side (the back surface side in FIG. 3) of the prism 111 of a reflecting optical element.

Hitherto, it has been necessary to provide an assembling space SP for assembling the drive shaft on the side of the second lens group and the drive shaft on the side of the fourth lens group in the center and therefore it has been difficult to reduce the dimensions in the height direction.

Then, in the embodiment, the first shaft 100 is provided with the drive shaft LS3 and the guide shaft G3 and the second shaft 101 is provided with the drive shaft LS4 and the guide shaft G4 for reducing the number of shafts from four to two for eliminating the need for the members involved in the shafts, thereby providing a free space.

Thus, the number of the shafts is reduced and the first shaft 100 and the second shaft 101 are disposed in parallel with the drive shaft LS3 and the guide shaft G3 opposed to the drive shaft LS4 and the guide shaft G4, whereby it is made possible to align both the shafts at both ends and a free space is provided in the center for making it possible to reduce the dimensions in the height direction. In the example shown in FIG. 3, the drive shafts LS3 and LS4 are formed each with a male screw and the guide shaft G3 and G4 are formed each with a smooth surface.

Further, using the fact that the first shaft 100 and the second shaft 101 extend in the second optical axis direction, the motors M3 and M4 are also packed in free space at the rear of the prism 111 for making it possible to reduce the dimensions in a width direction (direction orthogonal to the second optical axis).

Thus, in addition to slimming down, the dimensions are reduced in the height direction and the width direction, thereby providing the image formation optical unit built entirely in a small and slim body of a mobile telephone, etc.

As described above, the number of the parts is decreased, whereby the image formation optical unit whose dimensions can be further reduced is implemented.

In the embodiment, the zoom lens of the refractive optical system is taken as an example, but a zoom lens as disposed in a cylindrical lens barrel may be adopted.

While the invention has been described with reference to the exemplary embodiments, the technical scope of the invention is not restricted to the description of the exemplary embodiments. It is apparent to the skilled in the art that various changes or improvements can be made. It is apparent from the description of claims that the changed or improved configurations can also be included in the technical scope of the invention.

This application claims foreign priority from Japanese Patent Application No. 2006-80440, filed Mar. 23, 2006, the entire disclosure of which is herein incorporated by reference.

What is claimed is:

1. An image formation optical unit comprising:
a plurality of lens groups comprising a plurality of movable lens groups, wherein the movable lens groups are capable moving in a direction of an optical axis of the movable lens groups and comprise a first lens group and a second lens group;
a first shaft extending in parallel to the optical axis, the first shaft rotating to move the first lens group in the direction of the optical axis; and
a second shaft extending in parallel to the optical axis, the second shaft guiding the first lens group when the first lens group is driven by the first shaft and moves in the direction of the optical axis, and the second shaft rotating to move the second lens group in the direction of the optical axis,
the image formation optical unit forming subject light via the plurality of lens groups on a image formation surface.

2. The image formation optical unit as claimed in claim 1, wherein the first shaft guides the second lens group when the second lens group is driven by the second shaft and moves in the direction of the optical axis.

3. The image formation optical unit as claimed in claim 2, further comprising a reflecting optical element that reflects subject light incident along a first optical axis to a direction along a second optical axis crossing the first optical axis,
wherein the first lens group and the second lens group are placed on an image formation surface side rather than the reflecting optical element, and
wherein the first shaft and the second shaft are disposed so as to extend in parallel with the second optical axis.
